(19) United States
(12) Patent Application Publication
(10) Pub. No.: US 2016/0201608 A1
(43) Pub. Date: Jul. 14, 2016

(54) SYSTEMS AND METHODS CONTROLLING FAN PRESSURE RATIOS

(71) Applicant: United Technologies Corporation, Hartford, CT (US)

(72) Inventor: Daniel Bernard Kupratis, Wallingford, CT (US)

(73) Assignee: United Technologies Corporation, Hartford, CT (US)

(21) Appl. No.: 15/075,806

(22) Filed: Mar. 21, 2016

Related U.S. Application Data
(63) Continuation of application No. PCT/US2014/068193, filed on Dec. 2, 2014.
(60) Provisional application No. 61/915,263, filed on Dec. 12, 2013.

(51) Int. Cl. F02K 3/075; F01D 17/10; F02K 3/077; F01D 17/16; F01D 9/04

(52) U.S. Cl. CPC F02K 3/075; F01D 17/162; F01D 9/04; F02K 3/077; F01D 17/105; F05D 2220/36; F05D 2240/128; F05D 2240/55

(57) ABSTRACT

A system for varying the fan pressure ratio of a gas turbine engine is provided. The system may comprise a stator having a variable area component. The variable area component may be configured to adjust the inlet area on the main fan bypass. In this regard, the variable area component may be configured to restrict flow to the main fan bypass and/or divert flow to the core flow from a fan section of a gas turbine engine.

### CROSS-REFERENCE TO RELATED APPLICATIONS

This application is a continuation of, claims priority to and the benefit of, PCT/US2014/068193 filed on Dec. 2, 2014 and entitled “SYSTEMS AND METHODS FOR CONTROLLING FAN PRESSURE RATIOS,” which claims priority from U.S. Provisional Application No. 61/915,263 filed on Dec. 12, 2013 and entitled “SYSTEMS AND METHODS FOR CONTROLLING FAN PRESSURE RATIOS.” Both of the aforementioned applications are incorporated herein by reference in their entirety.

### FIELD OF INVENTION

The present disclosure relates to systems and methods for control of the fan pressure ratio in a gas turbine engine, and more particularly, to downstream control of the fan pressure ratio in a gas turbine engine.

### BACKGROUND OF THE INVENTION

A variable propulsor (e.g., a gas turbine engine) that is variable based on an adjustable fan pressure ratio (“FPR”) may be desirable as an alternative to adaptive fans that use clutches to change stage pressure ratio. Moreover, a gas turbine engine with an adjustable fan pressure ratio may have a higher reliability and lower overall cost as compared to adaptive fans.

### SUMMARY OF THE INVENTION

In various embodiments, a gas turbine engine may comprise a first fan, a flow splitter and a stator. The flow splitter may be in fluid communication with the first fan. The flow splitter may be configured to divert airflow between a main fan bypass and a core flow. The stator may comprise a moveable vane. The moveable vane may be configured to vary the inlet flow area of the main fan bypass.

In various embodiments, a fan section may comprise a plurality of fan stages, a splitter, a first fan and a stator. The splitter may be adjacent to and downstream of a least a portion of the plurality of fan stages. The first fan may be a fan in the plurality of fan stages. The first fan may be configured to conduct a flow to the splitter. The flow may be split by the splitter between the main fan bypass and the core flow. The stator may comprise a variable outer portion and a fixed inner portion. The variable outer portion may be configured to control a fan pressure ratio of the plurality of fan stages.

In various embodiments, a propulsor may comprise a fan stage, a main fan bypass, a core, a flow splitter and a stator portion. The fan stage may comprise a plurality of fan-stator sections. The main fan bypass may be fluid communication with the fan stage. The core may be in fluid communication with the fan stage. The flow splitter may be configured to split flow between the main fan bypass and the core. The stator portion may be configured to modulate an inlet area of the main fan bypass to adjust flow between the main fan bypass and the core.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1A illustrates a cross-sectional view of a portion of a gas turbine engine, in accordance with various embodiments;

FIG. 1B illustrates a cross-sectional view of a portion of a gas turbine engine comprising a third stream, in accordance with various embodiments; and

FIG. 2 illustrates a partial cross-sectional view of the flow split between the main fan bypass and core flow of a gas turbine engine, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Different cross-hatching and/or surface shading may be used throughout the figures to denote different parts but not necessarily to denote the same or different materials.

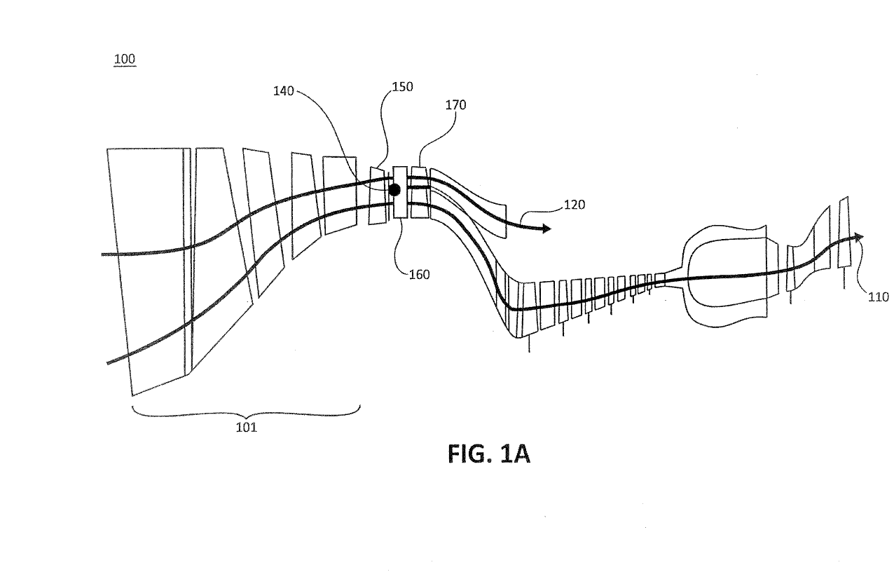

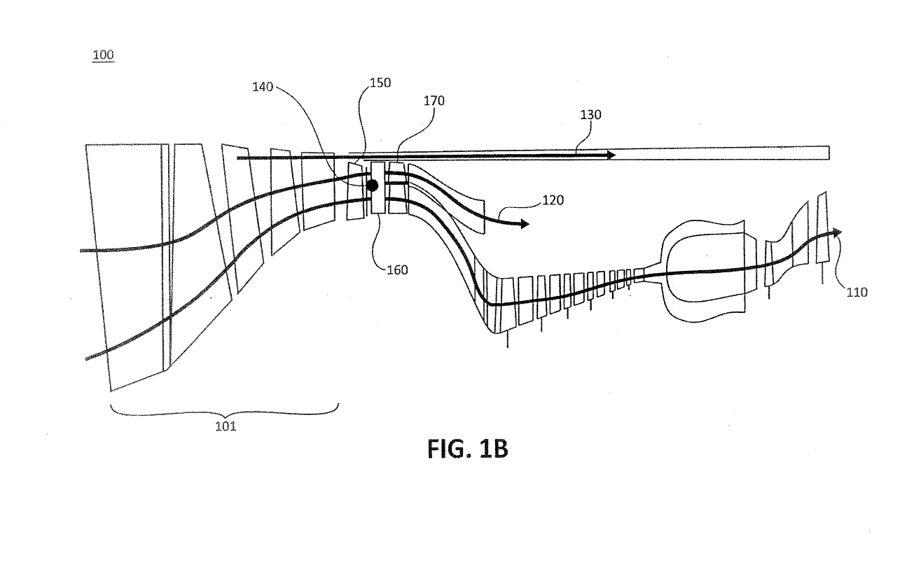

In various embodiments and with reference to FIGS. 1A and 1B, a gas turbine engine 100 may comprise a core flow 110 and a main fan bypass 120. Gas turbine engine 100 may also comprise a plurality of fans sections 101 that create and/or originate core flow 110 and main fan bypass 120. A plurality of fan sections 101 may comprise one or more fan rotor and stator pairings.

In various embodiments, gas turbine engine 100 may have a relatively high fan pressure ratio (“FPR”) (e.g., the ratio of the fan discharge pressure to the fan inlet pressure), due to multiplicative pressurizations of multiple stages of the fan (e.g., fan section 101). Exhaust from fan section 101 may be split at splitter 140 to main fan bypass 120 and core flow 110. Exhaust from fan section 101 may be fed or conducted into the hot section of gas turbine engine 100 to create core flow 110. Core flow 110 may be combined with fuel, combusted, and expanded across one or more turbine sections (e.g. one or more high pressure turbine stages and/or one or more low pressure turbine stages). The flow may then be combined with and/or mixed with flow through the main fan bypass 120 and exhausted through a nozzle. The nozzle may have a variable cross sectional area.

In various embodiments and with momentary reference to FIG. 1B, gas turbine engine 100 may further comprise a third stream 130. Third stream 130 may be configured to receive a portion of the flow from fan section 101. Third stream 130 may be configured with a separate nozzle (e.g. a nozzle that does not receive flow from main fan bypass 120 and/or core flow 110). In operation, where gas turbine engine 100 is required to produce a relatively high thrust and/or where an aircraft is required to operate at a relatively high Mach number (e.g. supersonic), the nozzle of third stream 130 may be closed and/or receive almost no flow. In this regard, flow through third stream 130 produces relatively little thrust and as such relatively low velocity for the aircraft during operation. Alternatively, where gas turbine engine 100 is commanded to operate at a relatively low speed or in a relatively fuel efficient configuration, third stream 130 may be activated. In this regard the nozzle associated with third stream 130 may be opened, changing and/or reducing the flow through main fan bypass 120 and core flow 110. Moreover, the FPR is reduced resulting in the engine creating less thrust but operating in a more fuel efficient configuration.

In various embodiments and with reference to FIGS. 1A and 1B, flow from fan section 101 may be split at splitter 140 into and/or through main fan bypass 120 and core flow 110. Flow from fan section 101 may contact stator 160 after splitter 140. Stator 160 may be capable of adjusting the FPR of gas turbine engine 100. In this regard, stator 160 may be capable of adjusting the amount of flow through main fan bypass 120 and/or core flow 110.

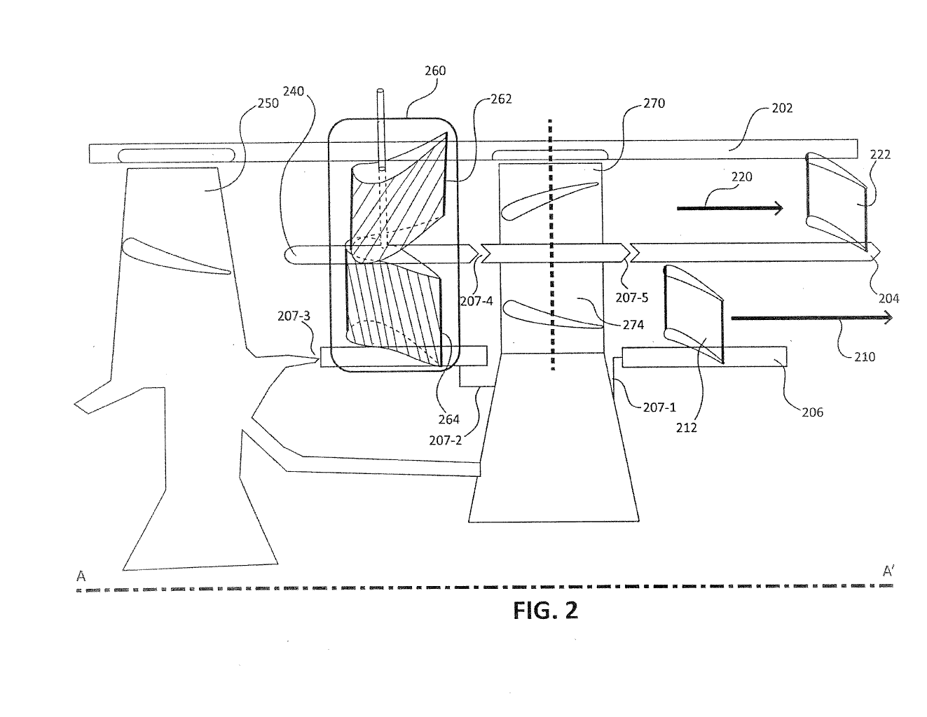

In various embodiments and with reference to FIG. 2, flow from first fan 250 may be split at splitter 240. The flow and associated pressure of gas turbine engine 200 may be controlled by at least a portion of stator 260. More specifically, stator 260 may comprise an outer stator portion 262 and an inner stator portion 264. Outer stator portion 262 may be a variable stator portion (e.g., a movable vane and/or a movable airfoil). Outer stator portion 262 may be configured to change the inlet area of main fan bypass 220. In this regard, outer stator portion 262 may be adjustable.

In various embodiments, outer stator portion 262 may be mounted to crank arm 266. Outer stator portion 262 may be adjustable about crank arm 266 to control the amount of flow from first fan 250 to the outer portion of second fan 270 along main fan bypass 220. In this regard, outer stator portion 262 may restrict and/or reduce the flow area (e.g., the inlet area of main fan bypass 220) to the outer portion of second fan 270, forcing and/or increasing the flow to core flow 210 and/or increasing the FPR.

In various embodiments, fluid flow through gas turbine engine 200 may be contained within outer casing 202. Main fan bypass 220 may be contained on a first side by outer casing 202 and on a second side by fixed case 204. Core flow 210 may be contained by fixed case 204 on a first side and a fixed inner surface 206 on a second side.

In various embodiments, flow from second fan 270 may be passed to main fan bypass 220 and then may be oriented and/or conditioned by a bypass deswirl vane 222. In this regard, bypass deswirl vane 222 may be configured to straighten and/or remove turbulence from the main fan bypass 220 before main fan bypass flow is conducted to the exhaust nozzle. Flow from second fan 270 may also be directed to core flow 210 and conditioned by a core deswirl vane 212. In this regard, core deswirl vane 212 may be configured to straighten and/or remove turbulence from core flow 210 before core flow 210 is passed to one or more compressors stages, combustor stages and/or turbine stages.

In various embodiments, outer stator portion 262 may variably restrict the flow area to main fan bypass 220. Outer stator portion 262 may be configured to adjust the FPR by adjusting the downstream flow area of first fan 250 and/or fan section 101 (as shown in FIG. 1). In this regard, the flow area of main fan bypass 220 may be restricted, increasing the FPR in fan section 101 (as show in FIG. 1). In response to this flow restriction, flow may be directed and/or forced through or past inner stator portion 264 and to core flow 210.

In various embodiments and with specific reference to FIG. 2, second fan 270 may comprise a rotor mid-span 272. Rotor mid-span 272 may longitudinally align with splitter 240 and fixed case 204. Moreover, rotor mid-span may be configured to partially separate main fan bypass 220 from core flow 210.

In various embodiments, the various joints connections and/or leakage paths between first fan 250, stator 260, second fan 270 and/or fixed case 204 may be sealed by one or more seals 207 (shown as seal 207-1, seal 207-2, seal 207-3, seal 207-4, seal 207-5). These seals 207 (e.g., seals 207-1, 207-2, and 207-3) may prevent loss of core flow 210 from the core flow path to the surrounding outer portions of the engine. This leakage may result in less core flow 210 to create thrust.

Seals 207-4 and 207-5 constrain the leakage of core flow from a core blade 274 into the main fan bypass 220. There may be a thermodynamic penalty due to leakage 207-5 since the core blade 274 did work that increased the pressure of core flow 210 and that leaks to the lower pressure of the main fan bypass 220. The thermodynamic penalty may be minimal relative to the benefit of adjusting the pressure ratio of main fan bypass 220. Moreover, the benefit of flow modulation between main fan bypass 220 and core flow 210 and/or the third stream (e.g., third stream 130 as shown in FIG. 1B). Leakage past seal 207-4 may have a minimal impact on the bypass ratio between the flow through main fan bypass 220 and core flow 210 in the same way as splitter 230 partitions flow between main fan bypass 220 and core flow 210. Leakage past seal 207-4 also may reduce the aerodynamic efficiency of the portion of blade 270 that passes through main fan bypass 220. However, similar to the thermodynamic penalty discussed above, the effect of the leakage and/or reduction in aerodynamic efficiency may be minimal relative to the benefit of adjusting the pressure ratio of main fan bypass 220 and/or modulating flow between main fan bypass 220 and core flow 210 and/or the third stream.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A gas turbine engine, comprising:
a first fan;
a flow splitter in fluid communication with the first fan and configured to divide an airflow between a main fan bypass and a core flow; and
a stator comprising a moveable vane configured to vary an inlet flow area of the main fan bypass.

2. The gas turbine engine of claim 1, wherein the moveable vane is configured to divert flow from the main fan bypass to the care flow.

3. The gas turbine engine of claim 2, wherein first fan is a portion of a fan section configured to supply the airflow to the splitter.

4. The gas turbine engine of claim 1, wherein the moveable vane is operatively coupled to a crank arm.

5. The gas turbine engine of claim 1, further comprising a third stream.

6. The gas turbine engine of claim 1, wherein the splitter is longitudinally aligned with the fixed case.

7. The gas turbine engine of claim 1, wherein flow through the main fan bypass is conditioned by a deswirler vane.

8. The gas turbine engine of claim 1, wherein the stator comprises an inner stator portion and an outer stator portion, and wherein the moveable vane is the outer stator portion.

9. The gas turbine engine of claim 8, wherein the inner stator portion is fixed.

10. The gas turbine engine of claim 1, further comprising a second fan configured to receive a flow from the first fan and via the stator.

11. The gas turbine engine of claim 10, wherein the second fan comprises a rotor mid-span that is configured to at least partially isolate the flow through the main fan bypass and the core flow.

12. A fan section, comprising:
a plurality of fan stages;
a splitter adjacent to and downstream of a least a portion of the plurality of fan stages;
a first fan of the plurality of fan stages configured to conduct a flow to the splitter, wherein the flow is split by the splitter between the main fan bypass and the core flow;
a stator comprising a variable outer portion and a fixed inner portion, the variable outer portion configured to control a fan pressure ratio of the plurality of fan stages.

13. The fan section of claim 12, further comprising a second fan of the plurality of fan stages downstream of the splitter and stator, the second fan comprising a rotor mid-span separating the second fan into an inner core portion and an outer bypass portion.

14. The fan section of claim 12, wherein the variable outer portion is operatively coupled to and moveable about a crank arm.

15. The fan section of claim 12, wherein the variable outer portion is configured to vary the inlet area of the main fan bypass.

16. A propulsor, comprising:
a fan stage comprising a plurality of fan-stator sections;
a main fan bypass in fluid communication with the fan stage;
a core in fluid communication with the fan stage;
a flow splitter configured to split flow between the main fan bypass and the core;
a stator portion configured to modulate an inlet area of the main fan bypass to adjust flow between the main fan bypass and the core.

17. The propulsor of claim 16, further comprising a third stream in fluid communication with the fan stage.

18. The propulsor of claim 16, wherein in stator portion is configured to adjust a pressure in the fan stage.

19. The propulsor of claim 16, wherein the main fan bypass and the core are separated by a fixed case.

20. The propulsor of claim 19, wherein leakage from flow through the core is reduced by a first seal and a second seal operatively installed in the fixed case at a second fan that is configured to rotate through the main fan bypass and the core.
